(19) United States
(12) Patent Application Publication
(10) Pub. No.: US 2025/0241393 A1
(43) Pub. Date: Jul. 31, 2025

(54) Chalk Liner with Cleaning Tool

(71) Applicant: DPG USA INC., Schaumburg, IL (US)

(72) Inventor: Nikhil GUPTA, Schaumburg, IL (US)

(73) Assignee: DPG USA INC., Schaumburg, IL (US)

(21) Appl. No.: 18/865,268

(22) PCT Filed: Jan. 27, 2023
(86) PCT No.: PCT/US2023/011675

§ 371 Date: Nov. 12, 2024

Related U.S. Application Data
(60) Provisional application No. 63/340,983, filed on May 12, 2022.

(51) Int. Cl. A41H 23/00

(52) U.S. Cl. CPC A41H 23/00

(57) ABSTRACT

A chalk liner including: (a) an elongate reservoir barrel for receiving powdered chalk; (b) a marking tip mounted on one end of the reservoir barrel and communicating with the interior of the reservoir barrel for receiving powdered chalk therefrom and having a marking wheel rotatably mounted in the marking tip and projecting outwardly therefrom; and (c) a cleaning tool mounted on the other end of the reservoir barrel.

### CROSS REFERENCE TO RELATED APPLICATION

This application is a National application of PCT Appl. No. PCT/US2023/011675 under 35 USC 371. PCT Appl. No. PCT/US2023/011675 is based on Provisional U.S. Patent Application Ser. No. 63/340,983, filed 12 May 2022 of the same title. The priorities of Applications PCT/US2023/011675 and 63/340,983 are hereby claimed and their disclosures are incorporated herein in their entireties.

### TECHNICAL FIELD

The present invention is directed to a chalk liner for marking fabrics while making garments. The device is of the class with an elongated reservoir barrel for housing a chalk reservoir of powdered chalk feeding a marking tip with a marking wheel, the improvement comprising a cleaning tool mounted on the reservoir barrel distal to the marking tip for removing chalk from a fabric.

### BACKGROUND

Chalk marking tools are known in the art. In U.S. Pat. No. 10,926,575 there is disclosed a three-way marker for sewing including a shell, a retention sleeve, compression spring, control tab, a reversible disk holder, and a cap. See, also, U.S. Design patent No. D918,297. Also noted is Clover's white chaco liner model 4712 liner, a “pen type” liner, as is seen at Amazon.com: Clover White Chaco Liner, 1 Count (Pack of 1): Arts, Crafts & Sewing, downloaded Feb. 23, 2022.

Although chalk liners are widely used, they have the drawback that they leave a chalk residue on the fabric which is quite persistent if not removed promptly, which conventionally requires another tool, such as a brush, sponge, felt or the like. Additional tools are difficult to keep track of on a busy work surface and may not be as effective as desired since chalk powder has an affinity for textile fibers and is oftentimes difficult to dislodge, especially when removal is not accomplished right away.

### SUMMARY OF INVENTION

A chalk liner includes: (a) an elongate reservoir barrel for receiving powdered chalk; (b) a marking tip mounted on one end of the reservoir barrel and communicating with the interior of the reservoir barrel for receiving powdered chalk therefrom and having a marking wheel rotatably mounted in the marking tip and projecting outwardly therefrom; and (c) a cleaning tool most preferably in the form of a brush assembly mounted on the other end of the reservoir barrel with a plurality of brush bristles for removing chalk from a marked surface.

Further details and advantages will become apparent from the following description and appended drawings.

### BRIEF DESCRIPTION OF THE DRAWINGS

The invention is described in detail below with reference to the drawings, wherein like numerals designate similar parts and wherein:

FIG. 1 is a perspective view of the inventive chalk liner with cleaning tool, fully assembled and including a cap over the marking tip;

FIG. 1A is a perspective view of the inventive chalk liner with cleaning tool, having the cap removed showing the marking tip and the marking wheel;

FIG. 1B is an enlarged perspective view of the assembled marking tip showing the marking wheel protruding from a gap;

FIG. 2 is an exploded perspective view of the chalk liner with cleaning tool of FIG. 1;

FIG. 3 is a perspective view of a brush assembly of the chalk liner with cleaning tool according to the invention;

FIG. 4 is a plan view of the brush assembly of FIG. 3;

FIG. 5 is an end view in elevation of the brush assembly of FIG. 3;

FIG. 6 is a side view in elevation of the brush assembly of FIG. 3;

FIG. 7 is a perspective view of the reservoir barrel of the chalk liner of FIG. 1;

FIG. 8 is a side view in elevation of the reservoir barrel of FIG. 7;

FIG. 9 is a perspective view of the upper dispensing tip member of the chalk liner of FIG. 1;

FIG. 10 is a side view in elevation of the upper dispensing tip member of FIG. 9;

FIG. 11 is a plan view of the upper dispensing tip member of FIG. 9;

FIG. 12 is an end view in elevation of the upper dispensing tip member of FIG. 9;

FIG. 13 is a perspective view of the lower dispensing tip member of the chalk liner of FIG. 1;

FIG. 14 is a side view of the lower dispensing tip member of FIG. 13;

FIG. 15 is a plan view of the lower dispending tip member of FIG. 13;

FIG. 16 is an end view in elevation of the lower dispensing tip member of FIG. 13;

FIG. 17 is a perspective view of the copper regulating spring of the chalk liner of FIG. 1;

FIG. 18 is a plan view of the regulating spring of FIG. 17;

FIG. 19 is an enlarged perspective view of the serrated marking wheel of the chalk liner of FIG. 1;

FIG. 20 is a plan view of the marking wheel of FIG. 19;

FIG. 21 is an end view in elevation of the marking wheel of FIG. 19;

FIG. 22 is an enlarged perspective view of the cap of the chalk liner of FIG. 1;

FIG. 23 is a plan view of the cap of FIG. 22;

FIG. 24 is a side view in elevation of the cap of FIG. 22;

FIG. 25 is an end view in elevation of the cap of FIG. 22;

FIG. 26 is a perspective view of a cleaning tool assembly of the chalk liner with cleaning tool having a rubber cleaning pad with a plurality of molded in projections according to the invention; and

FIG. 27 is a perspective view of still another cleaning tool assembly of the chalk liner with cleaning tool in the form of a cleaning pad according to the invention.

### DETAILED DESCRIPTION

Referring to the drawings, there is illustrated a chalk liner with cleaning tool 10 which includes a cleaning tool in the form of a brush assembly 12, a reservoir barrel 14 for receiving powdered chalk, a dispensing tip 16 formed by upper dispensing tip member 16(a) and lower dispensing tip member 61 (b), a regulating spring 18, a serrated marking wheel 20 and a cap 22.

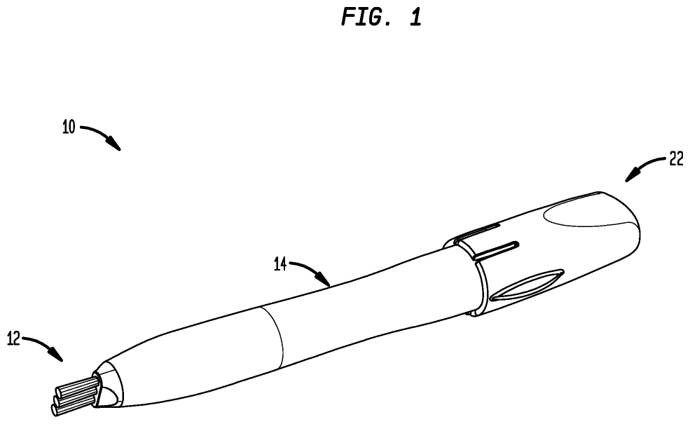

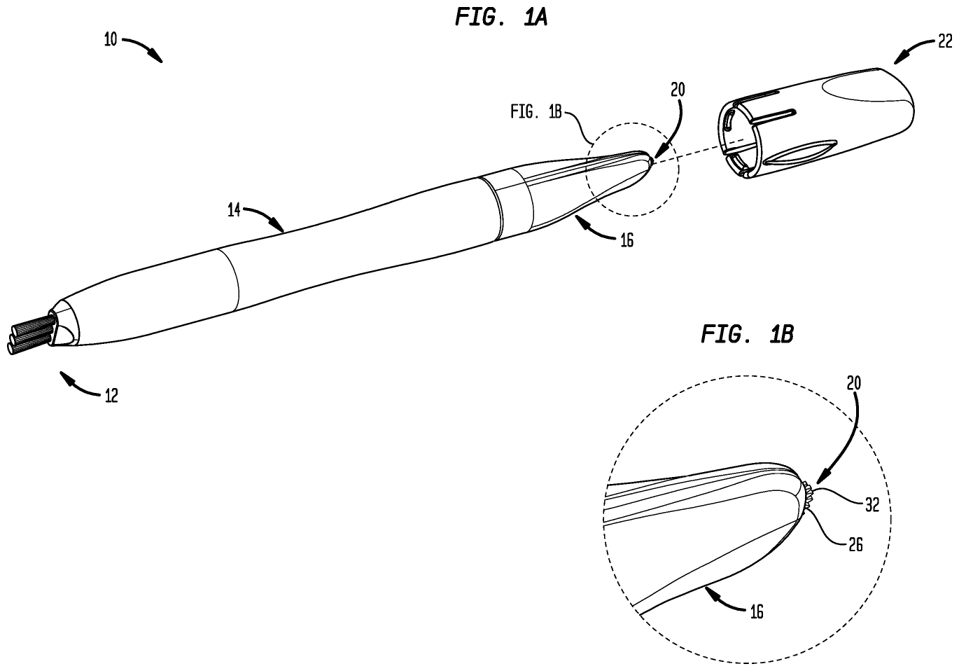

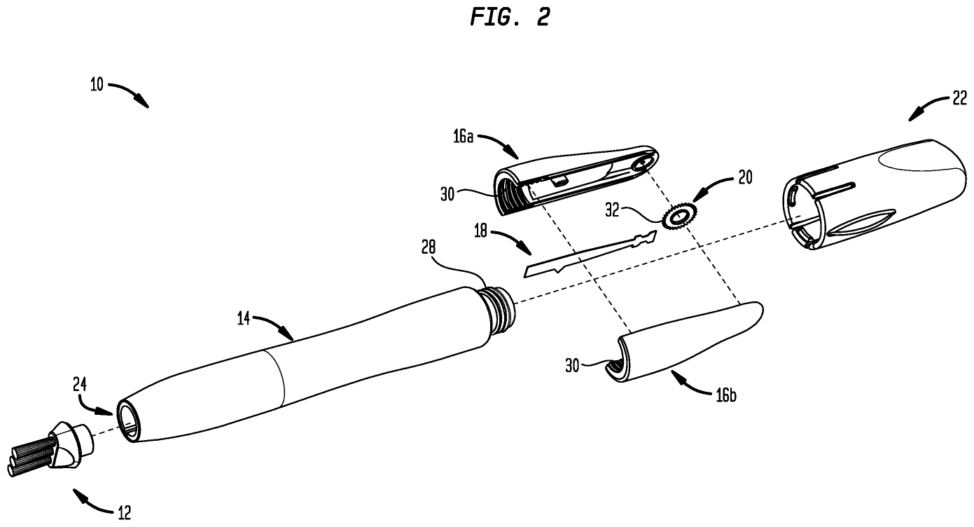

FIG. 1 shows chalk liner with cleaning tool 10 in assembled form. FIG. 1A shows the chalk liner with cap 22 removed, while FIG. 2 shows the various parts in an exploded view. It will be appreciated that cap 22 fits over dispensing tip 16. Brush assembly 12 fits into reservoir barrel 14, sealing an opening 24 of the reservoir barrel.

Members 16(a), 16(b) are assembled to each other and grip spring 18 and retain wheel 20 as is shown in FIGS. 1A and 1B. Note that serrated marking wheel 20 protrudes slightly from a gap 26 between assembled dispensing tip 16, but is free to rotate, limited by regulating spring 18 so that powdered chalk in reservoir barrel 14 does not leak out extensively when the chalk liner is not in use. That is, wheel 20 substantially seals gap 26 and powdered chalk is dispensed when wheel 20 rotates. Spring 18 engages to a plurality of teeth 32 on wheel 20 in order to modulate rotation in a preferred embodiment.

Barrel 14 with brush assembly 12 is secured to tip 16 by way of threads 28 on barrel 14 and threads 30 on dispensing tip 16. The tip may thus be unscrewed for purposes of refilling the reservoir barrel.

When marking fabrics or garments, fabric is marked by applying chalk powder thereto with the chalk liner. To this end, the chalk liner is held vertically oriented with marking wheel 20 on the fabric and pressure is applied while moving the liner in the desired direction. Spring 18 modulates rotation of the wheel and dispensing of chalk so that excessive dispensing does not occur.

When marking is no longer needed, residual chalk is brushed from the fabric, preferably promptly to avoid staining. Thus, a cleaning tool is conveniently provided that will not be misplaced since it is attached to the chalk liner.

In various embodiments, brush assembly 12 may be made of polypropylene with either polyester or nylon bristles.

The bristles of the brush mounted on the chalk liner are suitably project a length of from about 5 mm to 15 mm from the base member of the brush assembly, preferably a distance of from a base member 34 of from 7.5 mm to 12.5 mm or 8 mm to 11.5 mm in order to provide the desired functionality. The bristles resemble those used in tooth brushes and are arranged in bundles also resembling a tooth brush. The bristles may be made from thermoplastic nylon or thermoplastic polyester and are of suitable stiffness (initial modulus). Typical properties may be:

| Material | BRISTLE DIAMETERS |
|---|---|
| Nylon 6,12 | 0.127-0.508 mm |
| Polyester | 0.127-0.508 mm |

Initial Tensile Modulus at Various Humidities (k-Psi)

| RELATIVE HUMIDITY | 0% | 50% | 100% |
|---|---|---|---|
| Nylon 6,12 | 570 | 490 | 410 |
| Polyester | 540 | 530 | 515 |

Initial modulus is determined in accordance with test method ASTM-D3379 or equivalent and may suitably be from about 350 to 700 kpsi at 25° C. and 50% relative humidity. Individual bristles may have a fiber diameter of from about 0.075 to about 0.6 mm while bristle bundles may have a bundle diameter ranging from 1 to about 3 mm, depending on the selected fibers. See Monahan Filaments product brochure (downloaded Feb. 20, 2022). Typically, the bundle diameter at the base of the bundle is substantially smaller than at the bundle diameter at the top; for present purposes, the bundle diameter at the bottom of the bundle adjoining the base of the brush assembly is used. See FIG. 4.

The reservoir barrel is preferably made from clear polystyrene so that contained chalk powder can be readily observed. Cap 22 is made of polypropylene, while dispensing tip 16 is made of acrylonitrile-butadiene-styrene copolymer (ABS) for dimensional stability. Spring 18 and wheel 20 are suitably made of copper, although other metals may be used, if so desired.

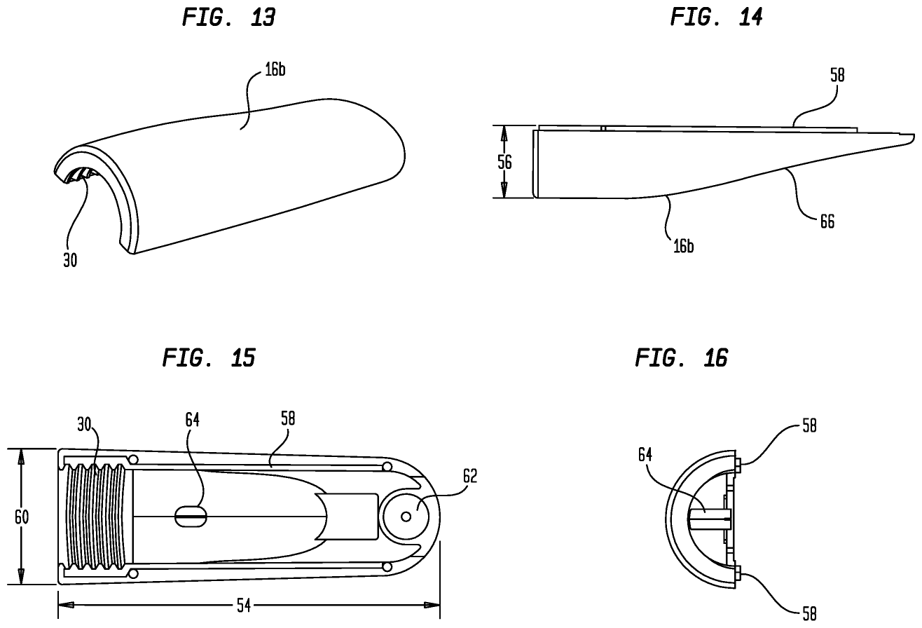

Further details on the various components are noted below in connection with FIGS. 3 through 25.

Referring to FIGS. 3 through 6, brush assembly 12 includes a base member 34 sized to fit opening 24 of barrel 14 at a cylindrical projection 36. A plurality of bristle bundles 38 are mounted to base member 34 which also has a transition skirt 40, having a filleted conical shape to avoid corners and for a more ergonomic design. The skirt has a generally circular shape at its base, which as a diameter, D, of about 10 mm. Base member 34 has a length 42 of about 8¾ mm, while the bristle bundles project from the base member a distance 44 of about 9½ mm, such that assembly 12 has an overall length of about 18¼ mm.

The individual fibers of the bristle bundles have the properties noted above.

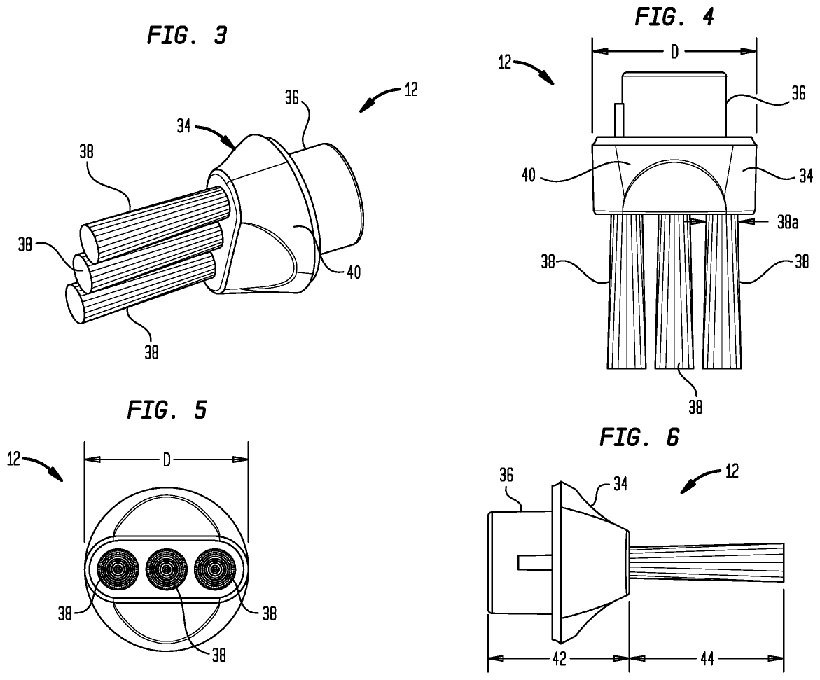

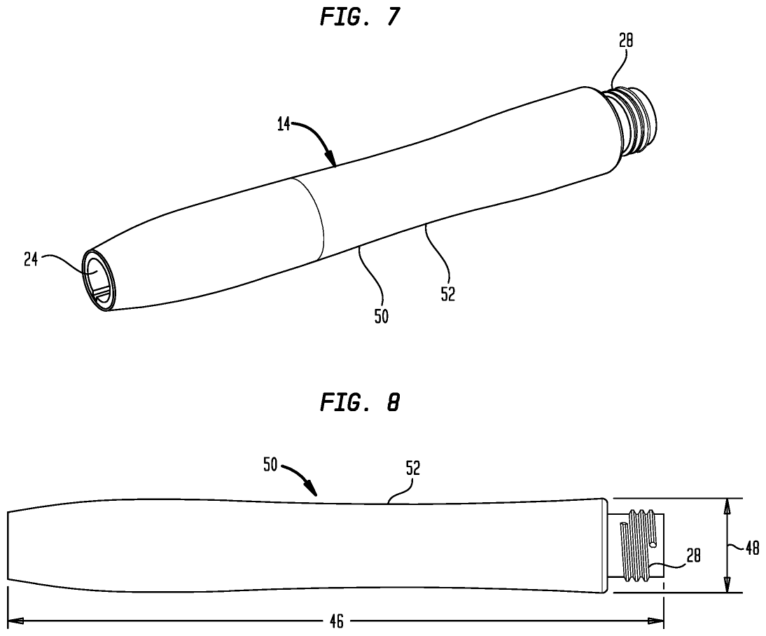

Referring to FIGS. 7 and 8, there is shown barrel 14 with opening 24 and threads 28. The barrel has an overall length 46 of about 95 mm as well as a diameter 48 proximate the threaded end of about 13½ mm. The barrel also has a slight concavity 50 about its medial portion 52, defining a slight decrease in diameter of 1.5 mm or less, which is perceived by users as providing a more comfortable gripping surface.

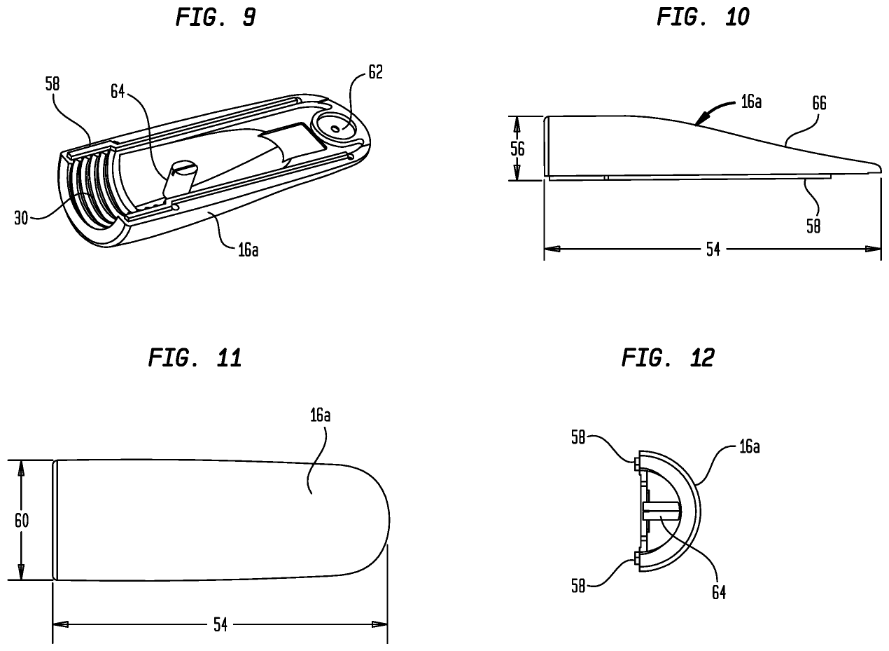

Referring to FIG. 9 through 12, there is illustrated upper dispensing tip member 16(a). Member 16(a) has a length 54 of about 38 mm and a height 56 of about 7 mm, as well as a width 60 of about 13½ mm. Also provided are threads 30 and a plurality of joining features 58 to secure member 16(a) to 16(b). Also provided is a recess 62 for mounting wheel 20; that is, for receiving a mounting hub 84 of wheel 20 and a mounting post 64 for mounting regulating spring 18. Note that member 16(a) has a “duck bill” profile 66 as seen in FIG. 10 to transition to the dispensing tip of the device as shown.

Lower member 16(b) is illustrated in FIGS. 13 through 16. It is seen that member 16(b) is similar to member 16(a) having a length 54, a height 56, a width 60, threads 30, joining feature 58, recess 62, mounting post 64 and profile 66 substantially matching those of member 16(a).

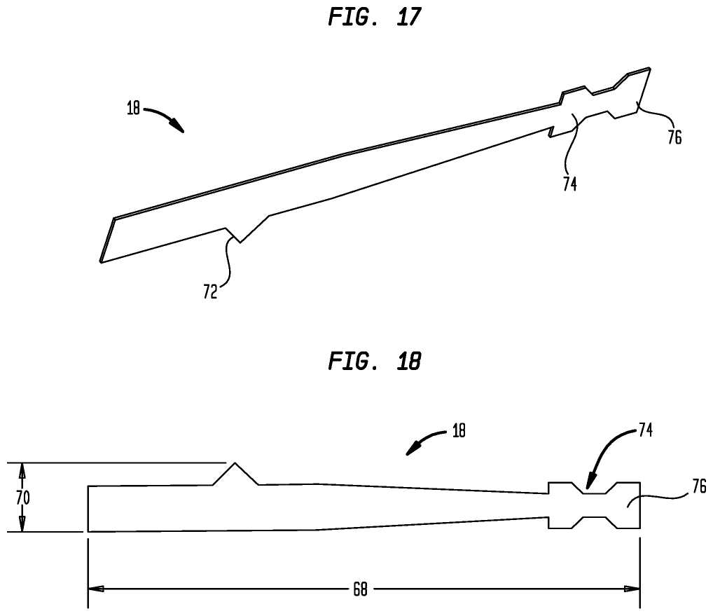

FIGS. 17 and 18 illustrate copper regulating spring 18 has a thickness of about 1 mm, a length 68 of slightly over 24 mm, and a width 70 of about 3 mm. Spring 18 is a single piece with a mounting projection 72 for mounting the spring in posts 64 of the dispensing tip, as well as a bow tie shaped spring terminus 74. When the device is fully assembled, outer edge 76 of spring 18 engage the teeth of marking wheel 20 in order to regulate rotation of the wheel as the chalk liner is dragged across a fabric surface with pressure on the fabric.

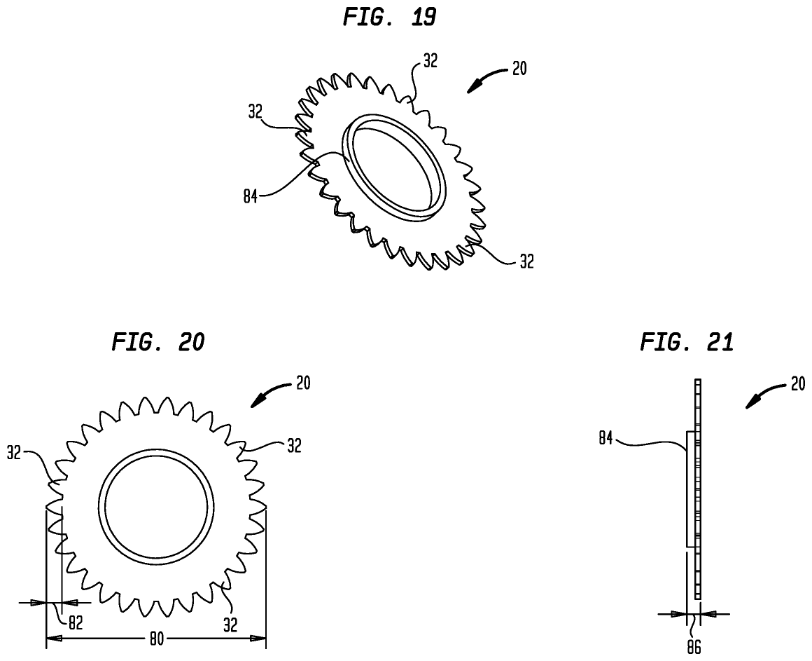

FIGS. 19 through 21 show serrated marking wheel 20. Wheel 20 has a plurality of teeth 32 about its outer periphery for engaging spring 18 and is circular in shape with a diameter 80 of 8 mm. Teeth 32 project outwardly a distance 82 of about 0.55 mm, suitably from about 0.35 mm to about 0.8 mm. Also provided on wheel 20 is a mounting hub 84 which rotatably mounts wheel 20 in recesses 62 of the dispensing tip when the device is assembled.

When assembled, the teeth of wheel 20 project from dispensing gap 26, as is seen in FIGS. 1A and 1B, a distance suitably from about 0.4 mm to 0.6 mm in a preferred embodiment.

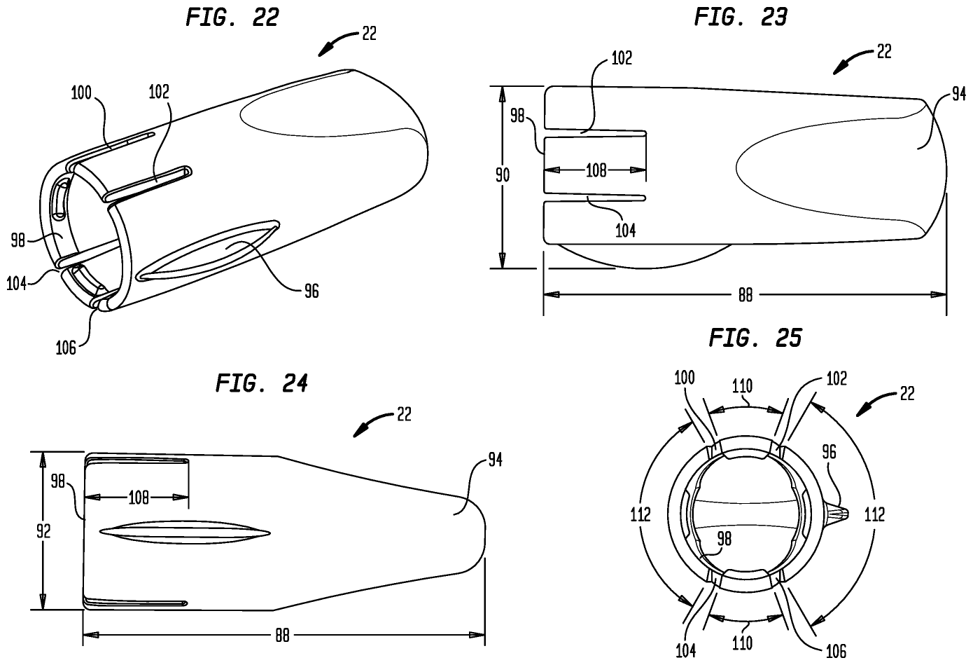

FIGS. 22 through 25 show cap 22 in more detail. Cap 22 has a length 88 of about 43 mm, a width 90 of about 19½ mm and a height 92 of about 17 mm, such that it frictionally engages tip 16 of chalk liner 10 and is removably coupled thereto. Cap 22 has a duck bill shape at 94 and is shaped to mate with tip 16, without excessive clearance. Also provided is a tab 96 to facilitate installation and removal of cap 22 from the chalk liner. Width 90 is slightly greater than height 92 due to the presence of tab 96, but is otherwise round at end 98 as shown in FIG. 25. It will be appreciated from the foregoing that the marking tip end of the chalk liner is larger than the brush assembly on the opposite end thereof, in terms of cross-section. It is desirable for cap 22 to fit securely over both ends of the chalk liner so that it does not become misplaced when the chalk liner is used, To this end, there is provided two pairs of longitudinal slots 100, 102 and 104, 106 which axially extend from the opening at 98 toward a distal end of the cap over a distance 108 of anywhere from about 20% to 50% of length 88, preferably about 25% to 35% of length 88. Slots 100, 102 and 104, 106 are separated from each other by an arc 110 of less than 90° and slots 100, 104 as well as slots 102 and 106 are separated by an arc 112 of greater than 90°. The plurality of slots provide a variable diameter to the cap opening at 98 so that it may be functionally secured to either the marking tip or the brush assembly despite the difference in cross-section. That is, the slotted structure flexes to a larger cross-section when attached to the marking tip and to a smaller cross-section when removed, so that the cap may be securely fitted to the cleaning tool end of the chalk liner.

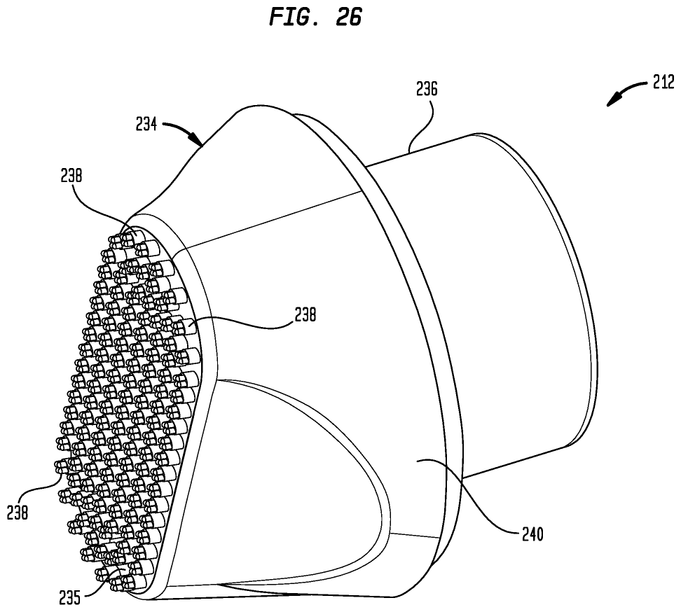

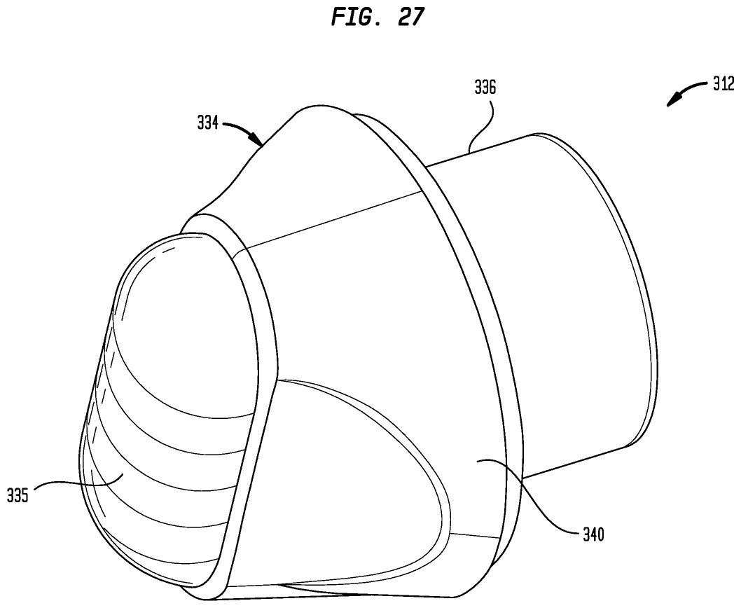

The inventive chalk liner has been described above in connection with a brush assembly for removing chalk dust from fabric comprising a plurality of bristles resembling those of a tooth brush; however, it will be appreciated that other chalk removal tools or cleaning tools may be provided on the end of the device distal to the marking tip. For example, a molded plastic or rubber cleaning tool with a plurality of elongated outward projections is suitable and for present purposes such a construction would be referred to as a plurality of brush bristles. Other molded cleaning tools could have a variety of constructions with or without outward projections such as that shown in FIGS. 26 and 27.

Referring to FIG. 26, a cleaning tool assembly 212 for mounting on reservoir barrel 14 includes a base member 234 sized to fit opening 24 of barrel 14 at a cylindrical projection 236. A rubber pad 235 with plurality of molded in projections 238 are mounted to base member 234 which also has a transition skirt 240, having a filleted conical shape.

Alternatively, a cleaning tool comprising an absorbent cleaning pad of felt, cloth such as woven terry cloth, sponge material, all of which may be moistened if so desired. In some cases simply a soft plastic or rubber pad made of rubber or polymeric elastomer may be employed. Referring to FIG. 27, a cleaning tool assembly 312 for mounting on reservoir barrel 14 includes a base member 334 sized to fit opening 24 of barrel 14 at a cylindrical projection 336. A cleaning pad 335 with a relatively smooth, slightly arched surface, is mounted to base member 334 which also has a transition skirt 340, having a filleted conical shape. Pad 335 may be arched slightly is so desired and is made of the materials recited above; namely felt, cloth such as woven terry cloth, sponge material, all of which may be moistened if so desired or a soft plastic or rubber pad made of natural or synthetic rubber or polymeric elastomer.

While the invention has been described in detail, modifications within the spirit and scope of the invention will be readily apparent to those of skill in the art. Such modifications are also to be considered as part of the present invention. In view of the foregoing discussion, relevant knowledge in the art and references and the attachment hereto discussed above in connection with the foregoing description including the Detailed Description and Background of the Invention, the disclosures of which are all incorporated herein by reference, further description is deemed unnecessary. In addition, it should be understood from the foregoing discussion that aspects of the invention and portions of various embodiments may be combined or interchanged either in whole or in part. Furthermore, those of ordinary skill in the art will appreciate that the foregoing description is by way of example only, and is not intended to limit the invention.

1-28. (canceled)

29. A chalk liner, comprising:
(a) an elongate reservoir barrel for receiving powdered chalk;
(b) a marking tip mounted on one end of the reservoir barrel and communicating with the interior of the reservoir barrel for receiving powdered chalk therefrom and having a marking wheel rotatably mounted in the marking tip and projecting outwardly therefrom; and
(c) a cleaning tool mounted on the other end of the reservoir barrel.

30. The chalk liner according to claim 29, wherein the marking tip is removably attached to the reservoir barrel.

31. The chalk liner according to claim 29, wherein the reservoir barrel is generally cylindrical.

32. The chalk liner according to claim 31, wherein the reservoir barrel has a concavity about a medial portion thereof.

33. The chalk liner according to claim 29, wherein the marking tip defines a gap through which the rotatable marking wheel projects.

34. The chalk liner according to claim 33, wherein the rotatable marking wheel projects through the gap a distance of from about 0.4 mm to about 0.6 mm.

35. The chalk liner according to claim 29, wherein the marking wheel is serrated, having teeth projecting outwardly from the marking tip a distance of from about 0.4 mm to 0.6 mm.

36. The chalk liner according to claim 29, wherein the marking tip defines a cylindrical internal recess and the marking wheel has an annular hub mounted in the cylindrical recess.

37. The chalk liner according to claim 29, wherein the marking tip includes a regulating spring for modulating rotation of the marking wheel.

38. The chalk liner according to claim 29, wherein the marking tip has a duck-bill shaped profile and further comprising a cap with a duck-bill shaped profile adapted to fit over the marking tip.

39. The chalk liner according to claim 29, further comprising a cap with an opening and having a plurality of longitudinally extending slots extending from the opening toward an end of the cap distal to the opening, whereby the opening of the cap is expandable and of variable cross-section.

40. A chalk liner, comprising:
(a) an elongate reservoir barrel for receiving powdered chalk;
(b) a marking tip mounted on one end of the reservoir barrel and communicating with the interior of the reservoir barrel for receiving powdered chalk therefrom and having a marking wheel rotatably mounted in the marking tip and projecting outwardly therefrom; and
(c) a brush assembly mounted on the other end of the reservoir barrel having a base member with a plurality of brush bristles mounted thereon for removing chalk from a marked surface.

41. The chalk liner according to claim 40, wherein the base member of the brush assembly includes a cylindrical mounting projection adjoined to the reservoir barrel and a transition section having a filleted conical shape.

42. The chalk liner according to claim 40, wherein the brush bristles are arranged in 2 to 4 bristle bundles.

43. The chalk liner according to claim 42, wherein the bristle bundles have a bundle diameter of from 1 mm to 3 mm.

44. The chalk liner according to claim 40, wherein the brush bristles project outwardly from the base member a distance of from about 5 mm to 15 mm.

45. The chalk liner according to claim 40, wherein the brush bristles have an initial modulus of from 350 kpsi to about 700 kpsi.

46. The chalk liner according to claim 40, wherein the brush bristles have a fiber diameter of from about 0.075 mm to 0.6 mm.

47. The chalk liner according to claim 40, wherein the brush bristles are selected from polyester brush bristles and nylon brush bristles.
